(19) United States
(12) Patent Application Publication
(10) Pub. No.: US 2026/0199990 A1
(43) Pub. Date: Jul. 16, 2026

(54) MILLING TOOL

(71) Applicant: CERATIZIT BESIGHEIM GMBH, Besigheim (DE)

(72) Inventor: Rico SCHNEIDER, Besigheim (DE)

(21) Appl. No.: 19/135,415

(22) PCT Filed: Nov. 17, 2023
(86) PCT No.: PCT/EP2023/082169

§ 371 Date: Jun. 4, 2025

(30) Foreign Application Priority Data
Dec. 7, 2022 (EP) 22211930.7

(51) Int. Cl. B23C 5/00; B23C 5/06; B23C 5/22; B23C 5/28

(52) U.S. Cl. CPC B23C 5/006; B23C 5/06; B23C 5/2208; B23C 5/28; B23C 2210/168; B23C 2210/40

(57) ABSTRACT

A milling tool has an end side, a plurality of cutting elements and a monolithic carrier region. Each of the cutting elements is fastened to the carrier region and is arranged and configured for end-side cutting. A plurality of flutes are made in the carrier region. Each of which flutes are open on the end side by way of an inlet gap with respect to in each case one of the cutting elements and is covered on the end side by way of an end wall portion which continues the carrier region monolithically.

The present invention relates to a milling tool.

In the cutting tool set out in DE 10 2016 116 466 A1, a chip guiding cover is releasably retained on a cutting head.

The chip guiding cover set out in DE 10 2016 116 466 A1 is intended to prevent chips which are already removed from falling onto a workpiece to be processed, but forms assembly gaps with respect to the cutting head, leads to a transverse force loading of the screw which retains it and is furthermore a component which has to be mounted in addition. Chips become jammed tight in the assembly gaps very easily and thus damage in the jammed state a workpiece to be processed. The retaining screw is excessively loaded transversely at excessively high speeds of the chip guiding cover by the centrifugal forces occurring here and is thus damaged. Since the chip guiding cover is an additional component, the assembly of the cutting tool is generally longer and thereby becomes more expensive and more intensive in terms of maintenance.

The object of the present invention is to provide a milling tool which more reliably prevents removed chips from falling on a workpiece to be processed and at the same time ensures that chips are prevented from becoming jammed, can be driven at higher speeds and can be produced more cost-effectively.

The technical objective of the present invention is achieved by the subject-matter of claim 1. Advantageous further developments of the invention may be taken from the dependent claims which can be freely combined with each other.

The milling tool has a front side, a plurality of cutting elements and a monolithic carrier region, wherein each of the cutting elements is secured to the carrier region and arranged and configured for cutting at the front, wherein there are recessed in the carrier region a plurality of chip grooves which are open at the front as a result of an inlet gap with respect to one of the cutting elements and are covered at the front by a front wall portion which monolithically continues the carrier region.

By the carrier region being monolithic, it is structurally held together without material seams and without any positive-locking connection, for example, as in the case of a material block, in which the chip grooves are milled and/or bored. In a correct, technical drawing, therefore, a uniform hatching is assigned to the carrier region in any cross section.

The term “monolithically continuing” is intended to be understood to mean that the front wall portions are configured without material seams and without any positive-locking connection on the carrier region. In a correct, technical drawing, the front wall portion and the carrier region have the same hatching in any cross section.

The front wall portions are formed by the chip grooves undercutting the carrier region at the front.

The inlet gaps are formed by the chip grooves penetrating the carrier region at the front.

The chip grooves receive the chips which are generated by the cutting elements during cutting at the front. The front wall portions prevent these chips from being discharged from the chip grooves at the front, particularly when the milling tool surface-mills a low base region, from where chips which have been discharged can be removed only with difficulty, and even if the cutting tool has stopped rotating, that is to say that no chip discharge supported by centrifugal force is possible any more in the chip grooves.

By each of the cutting elements being secured to the carrier region and being arranged and configured for cutting at the front, the cutting elements each project partially from the front side in order to be actively cutting during milling at the front.

The milling tool extends along from a rotation axis and is, because it is a milling tool, configured for cutting with respect to an advance direction transversely to the rotation axis and for simultaneously cutting with respect to another advance direction parallel with the rotation axis.

According to an advantageous further development, at least one of the chip grooves is covered transversely relative to the inlet gap which opens it to a greater extent than this inlet gap is wide. The corresponding width of the inlet gap is measured at the front between two gap edges at the same chip groove, wherein one gap edge is formed by a front cutting edge of one of the cutting elements and the other gap edge is formed by a front edge of one of the front wall portions.

By at least one of the chip grooves being covered at the front by one of the front wall portions to a greater extent than the inlet gap is wide, the carrier region is undercut by this chip groove at the front over a particularly large extent, whereby the chips received by the chip groove are prevented to a particularly large extent from being discharged from the chip groove at the front. Preferably, each of the chip grooves is covered at the front by one of the front wall portions to a greater extent than the inlet gap which opens it is wide.

According to an advantageous further development, at least one of the front wall portions is chamfered at the side of the chip groove which is covered by it. By the front wall portion being chamfered in this manner, the chips generated by the corresponding cutting element are introduced into the chip groove in a guided manner. Preferably, each of the front wall portions is chamfered at the side of the chip groove which is covered by it.

According to an advantageous further development, the chamfered front wall portion is chamfered at an inner chamfer angle in the range from 10° to 75°. The range from 10° to 75° is optimum with respect to adequate wall thickness of the front wall portion and simultaneous maintenance of the advantageous chip guiding which is provided by the chamfering.

According to an advantageous further development, the carrier region is undercut at the front in a concave manner by at least one of the chip grooves. Thus, the chip groove can be produced by milling and/or boring, wherein at the same time the chip guiding of the corresponding front wall portion is improved. Preferably, the carrier region is undercut at the front side in a concave manner by each of the chip grooves.

According to an advantageous further development, the carrier region has at least one coolant channel which is monolithically closed at the front by the carrier region and which opens in the region of one of the chip grooves. Therefore, the coolant channel can be produced, for example, by a bore in the carrier region and ensures in a flooded state a coolant flooding of the chip space recess, in the region of which it opens. Preferably, the carrier region has a plurality of coolant channels which are monolithically closed at the front by the carrier region and which open in the region of one of the chip grooves.

According to an advantageous further development, at least one of the cutting elements is positioned obliquely in an axially backward direction for reflecting coolant. If, therefore, the coolant from the coolant channel strikes the cutting element, the coolant is reflected by the front side away into the corresponding chip groove, whereby a suction action which draws the chips into the chip groove is produced.

The at least one of the cutting elements is positioned obliquely in an axially backward direction for reflecting coolant by this cutting element being positioned at the side of the chip groove associated therewith at a coolant reflection angle which is defined in the viewing direction perpendicular to a rotation axis of the milling tool by an angled member which is arranged parallel with the rotation axis and an angled member which follows the axial extent of this cutting element at the side of the chip groove, wherein the angled member which follows the axial extent of this cutting element leads the other angled member in a rotationally driven state of the milling tool. Preferably, the coolant reflection angle is in the range from 10° to 25° because this is optimum for the suction action by a relatively great underpressure being built up in the chip groove which is associated with this cutting element.

The angled member, which follows the axial extent of this cutting element, of the coolant reflection angle can also follow this axial extent of the cutting element in that this angled member follows the axial extent of a plate seat, in which the cutting element is secured.

If the at least one cutting element has a circumferential cutting edge, the angled member, which follows the axial extent of this cutting element, of the coolant reflection angle follows this circumferential cutting edge in the viewing direction perpendicular to the rotation axis.

Preferably, each cutting element is positioned obliquely in an axially backward direction for reflecting coolant.

According to an advantageous further development, at least one of the chip grooves is terminated in a state not covered opposite the front side. In a rotationally driven state, the chips are thrown out of this groove covered in this manner so that a chip jam is thereby prevented. Preferably, each of the chip grooves is terminated in a non-covered state opposite the front side. Furthermore, the suction action is increased if the at least one cutting element is positioned obliquely in an axially backward direction for reflecting coolant and associated with this chip groove which is not covered in this manner.

According to an advantageous further development, at least one of the chip grooves is not covered at least circumferentially. The chip groove which is not covered in this manner receives chips generated at the circumference, can be emptied particularly simply and can also be produced cost-effectively by milling. The term “circumferentially” is intended to be understood to mean that the milling tool has a circumferential side which surrounds the milling tool, as, for example, a cylindrical covering face surrounds a cylindrical member. Preferably, each of the chip grooves is not covered at the circumference.

According to an advantageous further development, at least one of the cutting elements is releasably secured to the carrier region in a reversible manner by a clamping element. The cutting element which is releasably secured in a reversible manner can be changed in a particularly simple manner. The clamping element may be, for example, a screw which engages in a thread of the carrier member. Preferably, each of the cutting elements is releasably secured to the carrier region in a reversible manner by a clamping element.

According to an advantageous further development, the clamping element is inserted into the carrier region transversely to a longitudinal extent of the milling tool. The cutting element is thereby attached to the carrier region in a secure manner in a particularly stable manner counter to centrifugal forces. Preferably, each clamping element is inserted into the carrier region transversely relative to the longitudinal extent of the milling tool.

According to an advantageous further development, at least one of the cutting elements has a cutting edge carrier and a cutting edge member which is carried by the cutting edge carrier in a materially engaging manner. The cutting element can thereby be exchanged even more easily and can be adjusted more precisely. The cutting edge member can be formed by a hard metal (cemented carbide) and the cutting edge carrier can be formed from a material which is different in this regard. Preferably, each of the cutting elements has a cutting edge carrier and a cutting edge member which is carried by the cutting edge carrier in a materially engaging manner.

According to an advantageous further development, at least one of the cutting elements is further arranged and configured for circumferential cutting. Consequently, this cutting element performs two cutting functions, whereby the number of cutting elements required for circumferential cutting is reduced. Preferably, each of the cutting elements is further arranged and configured for circumferential cutting.

According to an advantageous further development, the milling tool has at least five of the cutting elements and at least five of the chip grooves, wherein each of the cutting elements is further arranged and configured for circumferential cutting. The cutting volume is thereby increased so much that the surface-milling of engine blocks becomes particularly economical.

According to an advantageous further development, the carrier region has a plurality of webs, wherein a plate seat is formed in each web, wherein each of the front wall portions continues one of the webs monolithically in the circumferential direction opposite each of the plate seats. In a state of the cutting tool rotated in an actively cutting manner, therefore, the plate seat is leading with respect to each web and the front wall portion which continues it monolithically is trailing. By each of the front wall portions continuing one of the webs monolithically in the circumferential direction opposite each of the plate seats, they do not form any assembly gaps between the plate seats and the front wall portions at the same web, that is to say differently from in a chip guiding cover which has to be positioned and is positioned with respect to each of the cutting elements under a radially extending assembly gap in order to avoid damage to the cutting elements.

Additional advantages and favourable features of the invention will be appreciated from the following description of an exemplary embodiment with reference to the appended Figures, in which:

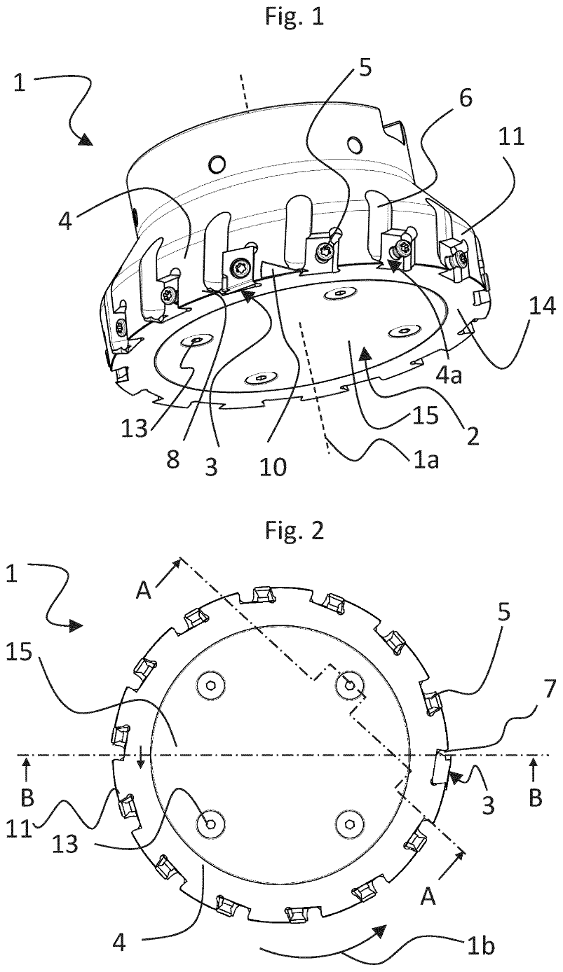

FIG. 1: shows a perspective illustration of a milling tool;

FIG. 2: shows the milling tool with a viewing direction towards the front;

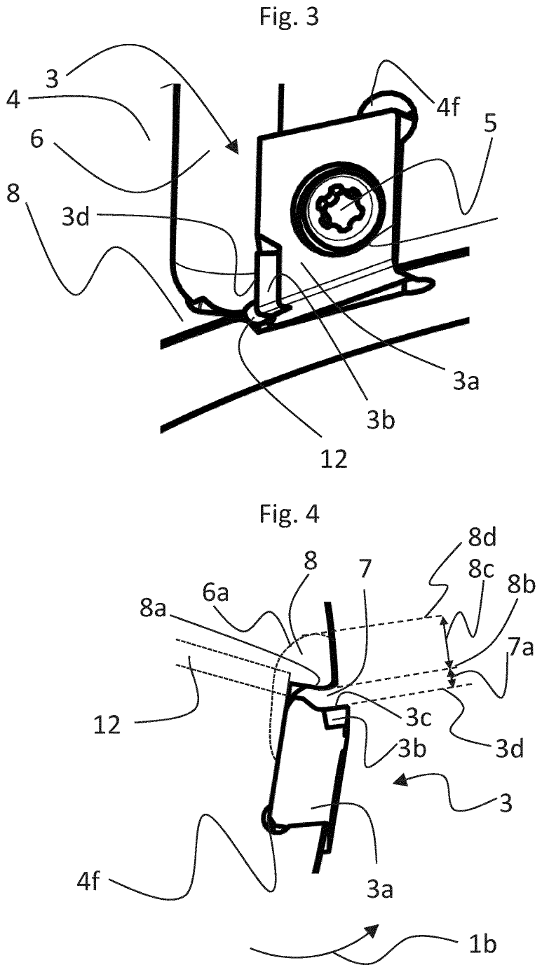

FIG. 3: shows an enlarged detail of the milling tool;

FIG. 4: shows another enlarged detail of the milling tool;

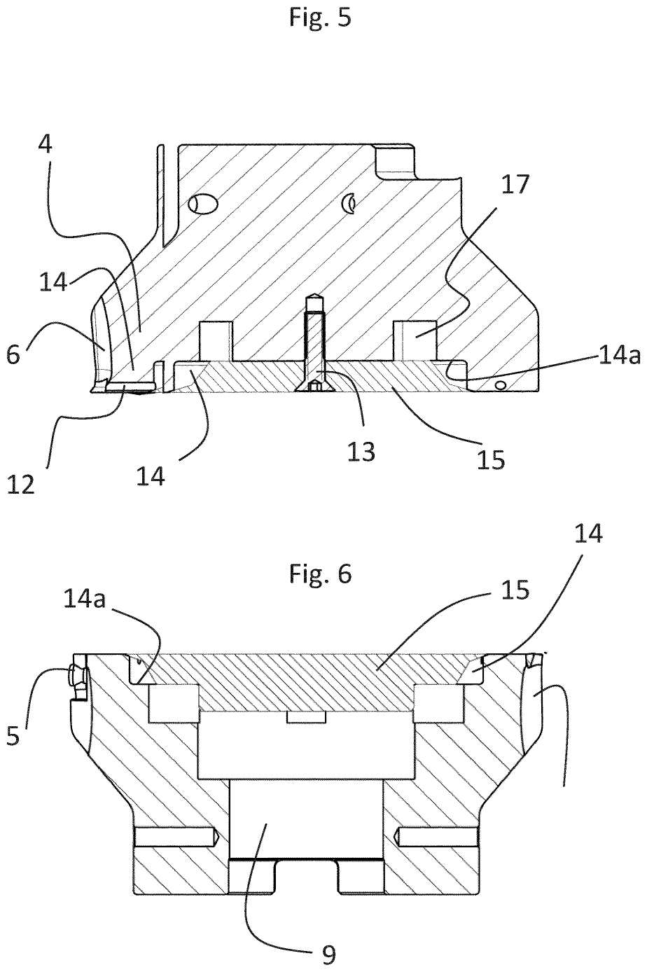

FIG. 5: shows a cross section of the milling tool along the line of section A-A in FIG. 2;

FIG. 6: shows a cross section of the milling tool along the line of section 3-3 in FIG. 2;

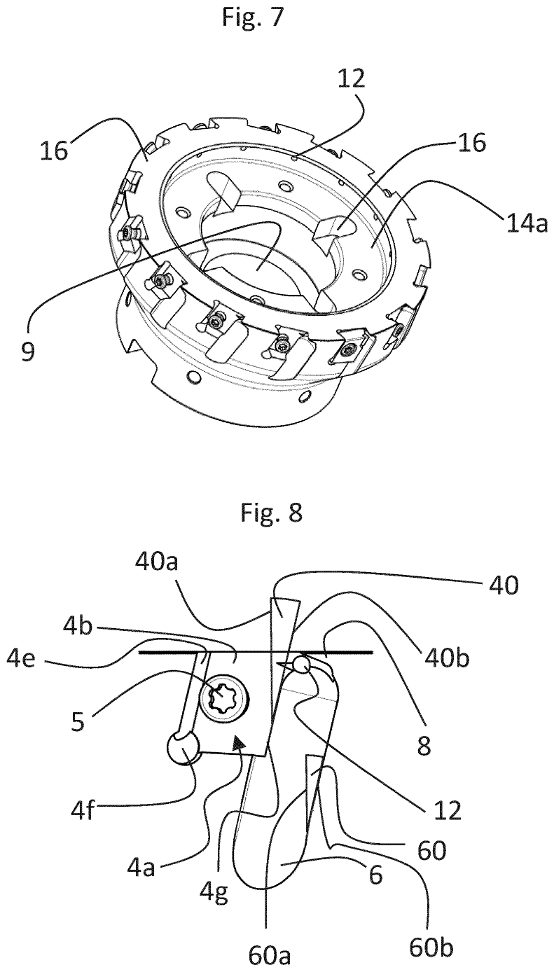

FIG. 7: shows another perspective illustration of the milling tool with a disassembled coolant guiding cover;

FIG. 8: shows an enlarged illustration of a plate seat of the milling tool;

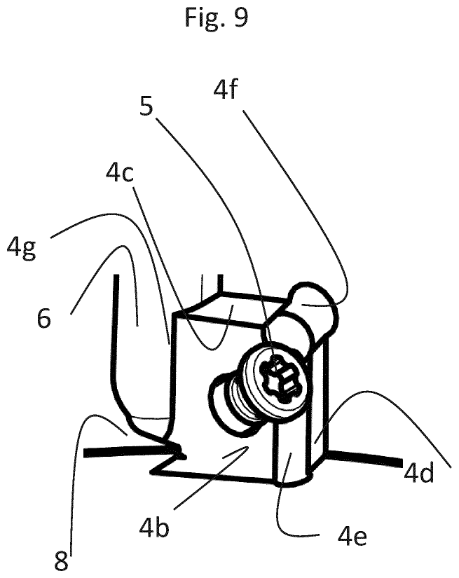

FIG. 9: shows another enlarged illustration of a plate seat of the milling tool.

FIGS. 1 to 9 show a milling tool 1 which is configured in a rotationally drivable manner with respect to a rotation axis 1a in a rotation direction 1b in an actively cutting manner for surface-milling with an advance movement perpendicular to the rotation axis 1a.

The milling tool 1 has a front side 2, a plurality of cutting elements 3 and a monolithic carrier region 4. The carrier region 4 is produced by subtraction by milling from a steel block.

FIG. 1 shows the milling tool 1 as a perspective view and FIG. 2 shows it in a viewing direction parallel with the rotation axis 1a and towards the front side 2. FIG. 3 shows an enlarged detail of the milling tool 1 in the region of one of the cutting elements 3 according to the perspective illustration in FIG. 1. FIG. 4 shows a partially transparent illustration of an enlarged detail of the milling tool 1 in the region of one of the cutting elements 3 according to the front view in FIG. 2. FIG. 5 shows a cross section through the carrier region 4 according to the line of section A-A in FIG. 2 and FIG. 6 shows a cross section through the carrier region 4 according to the line of section B-B in FIG. 2. FIG. 7 shows the milling tool 1 as a perspective illustration with a disassembled coolant guiding cover 15. FIG. 8 shows the plate seat of the milling tool 1 in detail. FIG. 9 shows the plate seat in detail according to another illustration.

FIG. 1 and FIG. 2 show particularly clearly that the carrier region 4 has a plurality of plate seats 4a, in which one of the cutting elements 3 is releasably secured in a reversible manner by a clamping screw 5; for reasons of clarity, only one of the cutting elements 3 is shown in specific terms, but it is disclosed that one of the cutting elements 3 is secured in each of the plate seats 4a. The clamping screws 5 are each screwed radially into the carrier region 4 with respect to the rotation axis 1a.

Each of the plate seats 4a has, as FIG. 9 shows in detail, an abutment face 4b which is tangential with respect to the rotation direction 1b, a front abutment face 4c, an abutment face 4d which is radial with respect to the rotation direction, a rounded edge 4e between the abutment faces 4b and 4d and a rounded edge 4f between the abutment faces 4c and 4d. The tangential abutment faces 4b are each delimited in the rotation direction 1b by a plate seat transition edge 4g.

The number of plate seats 4a as shown in FIG. 2 and therefore the same number of cutting elements 3 can be changed in accordance with a predetermined flight circle diameter, but should preferably be at least five because this is a minimum number suitable for surface-milling of conventional engine blocks.

FIG. 3 and FIG. 4 show particularly clearly that the cutting elements 3 each have a cutting edge carrier 3a and a cutting edge member 3b which is secured in a materially engaging manner to the cutting edge carrier 3a and which is made from a hard metal (cemented carbide). Each of the cutting edge carriers 3a contacts in a planar manner the abutment faces 4b, 4c and 4d of the plate seat 4a thereof. The cutting edge member 3b has a front cutting edge 3c which projects beyond the front side 2 and a circumferential cutting edge 3d which projects radially beyond the carrier region 4 with respect to the rotation axis 1a. The cutting elements 3 are therefore configured and arranged for cutting at the front and at the circumference, respectively.

FIG. 1 shows that a plurality of elongate chip grooves 6 are milled into the carrier region 4, that is to say are recessed therein. The chip grooves 6 partially penetrate the front side 2 at the front so as to form an inlet gap 7 at the front with respect to one of the cutting elements 3, as in particular FIG. 4 shows in its partially transparent illustration. For reasons of clarity, only one of these chip grooves is designated 6 in the Figures.

As a result of the partially transparent illustration, FIG. 4 shows by way of example for each chip groove 6 that the chip grooves 6 partially undercut the carrier region 4 at the front so that a plurality of front wall portions 8 which monolithically continue the carrier region 4 and thus partially cover one of the chip grooves 6 at the front are formed so that chips received by the chip grooves 6 are prevented from being discharged at the front out of the inlet gaps 7. Each of the front wall portions 8 has a front edge 8a at the front.

In FIG. 4, in the viewing direction parallel with the rotation axis 1a and towards the front side the maximum outer circumference 6a, which is not covered at the front by one of the cutting elements 3, of one of the chip grooves 6 is depicted. In a non-transparent illustration, the outer circumference 6a would not be able to be seen in the front view according to FIG. 4.

On the basis of the extent of the outer circumference 6a, it can be seen that the chip grooves 6 undercut the carrier region 4 so as to follow the rotation direction 1b opposite the front cutting edge 3c and additionally inwardly in the radial direction, that is to say undercut radially behind the abutment face 4b when taken together with the plate seat 4a illustrated to an enlarged extent in FIG. 1.

Consequently, the front wall portion 8 covers the chip groove 6 radially inwardly with respect to the rotation direction 1b partially opposite the cutting element 3 and with respect to the rotation direction 1b partially with respect to the rotation direction 1b so that the chip groove 6 is also covered in the radial direction behind the plate seat 4a.

FIG. 4 further shows for all the inlet gaps 7 by way of example that the inlet gap 7 is formed at the front by the spacing from the front cutting edge 3c and the front edge 8a. A front gap width 7a is measured, when viewing the front side 2 as the spacing between a linear extrapolation line 30d of the front cutting edge 3c and a measurement line 8b which is displaced parallel therewith and which contacts the front edge 8a first with such a displacement, wherein the gap width 7a is the spacing, measured perpendicularly to the extrapolation line 30d, between the extrapolation line 30d and the measurement line 8b.

A circumferential depth 8c, which is measured with respect to the rotation direction 1b is associated with the front wall portion 8 similarly to the measurement of the gap width 7a starting from the front edge 8a. The circumferential depth 8c is measured when viewing the front side 2 as the spacing between the measurement line 8b and another measurement line 8d which is displaced parallel therewith and which contacts the outer circumference 6a last, wherein the circumferential depth 8c is the spacing, measured perpendicularly to the measurement line 8b, between the measurement line 8b and the additional measurement line 8d.

FIG. 4 shows by way of example for each of the chip grooves 6 that it is covered transversely to the inlet gap 7 to a greater extent by the front wall portion 8 than the inlet gap 7 is wide by the circumferential depth 8c being greater than the gap width 7a.

FIG. 1 shows that each of the front wall portions 8 when viewed in the direction perpendicular to the rotation axis 1a is chamfered at an inner chamfer angle 10. The inner chamfer angle 10 is in the range from 10° to 75°. Each of the front wall portions 8 is rounded in a concave manner in the viewing direction perpendicular to the rotation axis 1a further at the side of the chip groove 6 covered by it outside the location where it is chamfered at the inner chamfer angle 10, that is to say in the rotation direction 1b with greater spacing from the respective inlet gap 7.

FIG. 1 further shows that, opposite the front side 2, each of the chip grooves 6 is formed in a non-covered manner relative to the free chip outlet and with respect to the inlet gap 7 thereof which is shown particularly clearly in FIG. 4, so as to terminate in a trailing manner, wherein the term “trailing” relates to the fact that the milling tool 1 is rotated in the rotation direction 1b so that each of the chip grooves 6 transports the chips received by it away from the front side 2 with support by centrifugal force.

FIG. 1 further shows that the carrier region 4 has a number of webs 11 corresponding to the number of plate seats 4 which are formed by one of the chip grooves 6 and one of the plate seats 4; for reasons of clarity, only one of the webs is designated 11.

Therefore, one of the plate seats 4 is formed in each web 11 and one of the front wall portions 8 monolithically continues the web 11 opposite in the circumferential direction. When the front side 2 is viewed, the webs 11 are arranged alternately alternating with the chip grooves 6 in the rotation direction 1b.

One coolant channel 12 opens in each of the chip grooves 6 directly under the respective front wall portion 8, as FIG. 3 and FIG. 8 show particularly clearly. The coolant channel 12 extends in the carrier region 4 perpendicularly to the rotation axis 1a so that one coolant jet strikes one of the cutting elements 3 and, as a result of the oblique positioning, with respect to the rotation axis 1a, of the plate seats 4a is reflected away from the front side 2a axially backwards so that chips which are introduced into the respective inlet gap 7 are sucked away from the front side axially backwards. The corresponding suction action is increased in that the chip grooves 6 terminate in a non-covered state opposite the front side.

The cutting elements 3 are positioned obliquely by extending under the coolant reflection angle 40, shown in FIG. 8, at the side of the chip groove 6 which is associated with them, wherein the coolant reflection angle 40 in the viewing direction perpendicular to the rotation axis 1a is measured and is defined by an angled member 40a which is parallel with the rotation axis 1a and an angled member 40b which follows the axial extent of the cutting element 3 at the side of the chip groove 6, and which is in the range, measured in this manner, from 10° to 25°, wherein the angled member 40b is arranged in a leading manner with a rotation in the rotation direction 1b with respect to the angled member 40a. In FIG. 8, the coolant reflection angle 40 is 14° by way of example.

By the coolant reflection angle 40 being in the range from 10° to 25°, an optimum reflection, for the suction action described, of the coolant which is discharged from the respective coolant channel 12 is achieved at the cutting elements 3.

The angled member 40b follows in the viewing direction perpendicular to the rotation axis 1a one of the circumferential cutting edges 3d and additionally also the axial extent of the plate seat 4a.

The chip grooves 6 extend at a chip groove angle 60 which is measured similarly to the coolant reflection angle 40 and which is of the same size in terms of value, according to which the chip groove angle 60 is defined by an angled member 60a which is parallel with the rotation axis 1a and an angled member 60b which follows the respective main extent of the chip grooves 6, wherein the angled member 60b is arranged in a leading manner with respect to the angled member 60a with a rotation in the rotation direction 1b.

FIGS. 5, 6 and 7 show, when taken together, how the coolant is directed into the coolant channels 12. Thus, the carrier region 4 has a central coolant main channel 9, a plate-like recess 14 which is interrupted centrally by the coolant main channel, four transverse grooves 16 and an annular wall 16. The coolant channels 12 are formed in the annular wall 16 and are covered monolithically at the front by the annular wall 16. The coolant guiding cover 15 is releasably secured in a reversible manner to a base 14a of the recess 14 by cover screws 13 and is located outside the transverse grooves 16 on the base 14a in a sealing manner so that the coolant can flow from the coolant main channel 9 only through the transverse grooves 16 into the recess 14. The coolant guiding cover 15 is chamfered in two steps at the side of the coolant main channel 9 so that the coolant guiding cover 15 is spaced apart from the annular wall 14 radially with respect to the rotation axis 1a so that the coolant can be introduced into the coolant channels 12 in a manner directed at the coolant guiding cover 15 after being discharged out of the transverse grooves 16. The coolant guiding cover 15 additionally seals the recess 14 at the front.

FIG. 1 to FIG. 9 show the milling tool 1, wherein the chip grooves 8 are covered at the front as a result of the front wall portions 8 and are open at the front by an inlet gap 7 with respect to one of the cutting elements 3 so that the chips which are generated during cutting at the front are moved directly from the cutting elements 3 into the chip grooves 6, but are prevented from leaving by the front wall portions 8. The region left behind by the milling tool 1 during surface-milling is thereby better kept free of chips and chip jamming at the front is better avoided because the front wall portions 8 monolithically continue the carrier region 4.

The milling tool 1 provides a suction action during surface-milling, whereby the region which is left behind during the surface-milling is even better kept free of chips. The suction action is produced by the reflection of the coolant at the cutting elements 3 by the cutting elements 3 being positioned obliquely at the coolant reflection angle 40.

The milling tool 1 is not limited to the embodiment shown in FIG. 1 to FIG. 9, thus the cutting elements 3 can also be secured to the carrier region 4 in a materially engaging manner and/or additional cutting elements which cut only at the circumference can be provided.

1-15. (canceled)

16. A milling tool, comprising:
a front side;
a plurality of cutting elements; and
a monolithic carrier region having front wall portions, wherein each of said cutting elements is secured to said monolithic carrier region and disposed and configured for cutting at a front, wherein there are recessed in said monolithic carrier region a plurality of chip grooves which are each open at a front forming an inlet gap with respect to one of said cutting elements and are covered at the front by one of said front wall portions which monolithically continues said monolithic carrier region.

17. The milling tool according to claim 16, wherein at least one of said chip grooves is covered transversely relative to said inlet gap which opens it to a greater extent than said inlet gap is wide.

18. The milling tool according to claim 16, wherein at least one of said front wall portions is a chamfered front wall portion being chamfered at a side of said chip groove which is covered by said chamfered front wall portion.

19. The milling tool according to claim 18, wherein said chamfered front wall portion is chamfered at an inner chamfer angle in a range from 10°to 75°.

20. The milling tool according to claim 16, wherein said monolithic carrier region is undercut at a front in a concave manner by at least one of said chip grooves.

21. The milling tool according to claim 16, wherein said monolithic carrier region has at least one coolant channel which is monolithically closed at a front by said monolithic carrier region and said at least one coolant channel opens in a region of one of said chip grooves.

22. The milling tool according to claim 16, wherein at least one of said cutting elements is positioned obliquely in an axially backward direction for reflecting coolant.

23. The milling tool according to claim 16, wherein at least one of said chip grooves is terminated in a state not covered opposite said front side.

24. The milling tool according to claim 16, wherein at least one of said chip grooves is not covered at least circumferentially.

25. The milling tool according to claim 16, further comprising a clamping element, at least one of said cutting elements is releasably secured to said monolithic carrier region in a reversible manner by said clamping element.

26. The milling tool according to claim 25, wherein said clamping element is inserted into said monolithic carrier region transversely to a longitudinal extent of the milling tool.

27. The milling tool according to claim 16, wherein at least one of said cutting elements has a cutting edge carrier and a cutting edge member which is carried by said cutting edge carrier in a materially engaging manner.

28. The milling tool according to claim 16, wherein at least one of said cutting elements is arranged and configured for circumferential cutting.

29. The milling tool according to claim 16, wherein the milling tool has at least five of said cutting elements and at least five of said chip grooves, wherein each of said cutting elements is arranged and configured for circumferential cutting.

30. The milling tool according to claim 16, wherein said monolithic carrier region has a plurality of webs, each of said webs has a plate seat formed therein, wherein each of said front wall portions continues one of said webs monolithically in a circumferential direction opposite each of said plate seats.
